(19) United States
(12) Patent Application Publication
(10) Pub. No.: US 2013/0255585 A1
(43) Pub. Date: Oct. 3, 2013

(54) AQUACULTURE METHODS & SYSTEMS

(71) Applicant: Steve HAMMAN, Carlsbad, CA (US)

(72) Inventor: Steve HAMMAN, Carlsbad, CA (US)

(21) Appl. No.: 13/789,586

(22) Filed: Mar. 7, 2013

Related U.S. Application Data
(60) Provisional application No. 61/607,695, filed on Mar. 7, 2012.

(51) Int. Cl. A01K 61/00

(52) U.S. Cl. CPC A01K 61/00
USPC 119/200

(57) ABSTRACT

An aquaculture system includes a plurality of containment chambers for containing aquatic organisms, and a continuous linkage mechanism for coupling with each of the chambers, respectively. The continuous linkage mechanism is configured to move each of the chambers, respectively, about a cyclical path within a body of water. In this regard, a depth of the body of water is efficiently utilized, operational footprint is reduced, exposure to light and other nutrients is controlled, and harvesting of diverse species and/or periodic harvesting of species using planned maturation cycles becomes possible.

### CROSS-REFERENCE TO RELATED APPLICATIONS

This application claims benefit of priority to U.S. Provisional Application Ser. No. 61/607,695, filed Mar. 7, 2012; the contents of which are hereby incorporated by reference.

### BACKGROUND OF THE INVENTION

1. Field of the Invention

This invention relates to systems and methods for aquaculture; and more particularly, to a multi-chamber aquaculture system configured to rotate the multiple chambers about a cyclical path within a body of water, and methods associated therewith.

2. Description of the Related Art

Aquaculture, also known as aquafarming or seafood farming, is the farming of aquatic organisms such as fish, crustaceans, mollusks and aquatic plants. An excellent summary of current techniques and benefits of aquaculture can be found on the internet at hup://www.wikepedia.org/wiki/Aquaculture; however, in general, aquaculture involves the controlled growth and harvesting of various aquatic species.

Aquaculture is one of a range of technologies needed to meet increasing global demand for seafood, support commercial and recreational fisheries, and restore species and marine habitat.

Mariculture is a specialized branch of aquaculture involving the cultivation of marine organisms for food and other products in the open ocean, an enclosed section of the ocean, or in tanks, ponds or raceways which are filled with seawater. However, various techniques also provide aquaculture within fresh water for farming fresh-water species.

Current aquaculture techniques are plagued with problems such as: disease and food safety challenges related to an inability to properly clean and maintain the tank, raceway or pond; relatively large costs associated with large floor-space or area required by the large tanks and raceways; relatively inadequate surface area per gallon of water resulting in minimal surface for organisms in the early development stages; shallow raceways tend to be limited with regards to homogeneous oxygen and nutrient development amongst organisms; inability for partial harvesting; non-conducive to farming of multiple species within the same volume of water; and open water farming presents additional problems of predators and introduction and spread of contaminants.

Thus, it would be beneficial to provide aquaculture systems and methods adapted to solve these and other problems in the art.

### SUMMARY OF THE INVENTION

The aquaculture systems described herein generally include a plurality of individual chambers, each being configured for farming one or more aquatic organisms therein, and a continuous linkage mechanism adapted to engage each of the plurality of chambers and being further configured to translate or move the chambers about a cyclical path within a body of water, wherein the chambers are rotated upwardly about a first depth stack, downwardly about a second depth stack, and laterally therebetween. The depth stacks each comprise a plurality of chambers being spaced apart in a predetermined manner, one above another, forming a vertical stack. As the continuous linkage mechanism moves, each of the chambers is respectively moved therewith about the cyclical path.

Because the chambers are configured to translate about the cyclical path, each chamber can be individually positioned at a top end, and optionally removed from the linkage mechanism for harvesting organisms and accessing the chamber for maintenance such as cleaning.

Multiple chambers within the system provide for a diversification of aquatic species that can be farmed within the aquaculture system. Additionally, various species can be grown in overlapping cycles for harvesting organisms in a periodic manner.

Moreover, an amount of light can be controlled by positioning targeted chambers at the top end where light more adequately permeates the water. In this regard, certain organisms requiring more or less light can be accommodated using the aquatic systems herein.

Additionally, certain nutrients and other materials tend to migrate to either the top or bottom portions of the body of water and it may be desirable to position certain chambers containing particular organisms at various depths within the body of water for certain desirable periods of time.

In another aspect, a method for farming aquatic organisms comprises: (i) placing one or more organisms in one or more chambers of a plurality of chambers in accordance with the aquaculture systems described herein; and (ii) translating the one or more chambers about a cyclical path within a body of water.

Other features and advantages will be recognized by those having skill in the art upon a thorough review of the appended detailed description and associated drawings.

### BRIEF DESCRIPTION OF THE DRAWINGS

FIG. 1 illustrates a chamber for use with the aquaculture system in accordance with an embodiment.

FIG. 2 illustrates a schematic of an aquaculture system in accordance with the embodiment of FIG. 1.

FIG. 3 illustrates a side view of the aquaculture system of FIG. 2.

FIG. 4 illustrates a top view of the aquaculture system of FIG. 2.

FIG. 5 illustrates a chamber for use with an aquaculture system in accordance with another embodiment.

FIG. 6 illustrates a schematic of an aquaculture system in accordance with the aquaculture system of FIG. 5.

FIG. 7 illustrates a side panel having a channel for guiding the chambers along the cyclical path.

FIG. 8 illustrates a flowchart describing a method for farming aquatic organisms using the aquaculture systems described herein.

FIG. 9 illustrates an aquaculture system in accordance with another embodiment.

FIG. 10 illustrates an aquaculture tank having multiple wells in accordance with certain embodiments.

### DETAILED DESCRIPTION OF THE PREFERRED EMBODIMENTS

In the following description, for purposes of explanation and not limitation, details and descriptions are set forth in order to provide a thorough understanding of various embodiments of the invention. However, it will be apparent to those skilled in the art that certain inventive features and embodiments may be practiced in other embodiments that depart from these details and descriptions but which yield substantially similar results. The following description of the preferred embodiments are therefore not intended to limit the spirit and scope of the invention, but rather, should be viewed as enabling those with skill in the art to make and use the invention in accordance with a plurality of practicable embodiments, including those described herein and those that would be obvious to those having skill in the art upon a review of this disclosure.

In a general embodiment, an aquaculture system comprises a plurality of chambers each coupled to a continuous linkage mechanism. Each of the chambers and the continuous linkage mechanism can be practiced in accordance with a myriad of embodiments, however, in general the system is adapted to translate or move each of the chambers coupled to the continuous linkage mechanism about a cyclical path within a body of water. The continuous linkage mechanism and chambers coupled therewith generally include a first vertical stack of chambers being spaced one above another, a second vertical stack of chambers, and one or more chambers positioned laterally between the first and second vertical stacks at a top end and a bottom end thereof.

In this regard, certain embodiments allow for each of the chambers to contain a distinct group of organisms such that a diversity of organisms can be concurrently farmed within the aquaculture system. A diversity of organisms may include a plurality of species, or a number of organisms being matriculated through various growth stages and separated by respective chambers. Operational area or footprint is reduced since vertical space within a body of water is utilized in an efficient manner using the continuous linkage mechanism to route the plurality of chambers through a vertical volume of water. Exposure of the organisms to light and nutrients for additional farming controls can be time-controlled by cycling each of the chambers about portions of the body of water for pre-determined time intervals. Other advantages will be recognized by those having skill in the art.

In certain embodiments, the continuous linkage mechanism may be controlled using one or more motors and a computerized control. Here, a CPU can be used to store a program for controlling the rotation of the chambers within the system by coupling the electronic inputs of the one or more motors with the CPU. Additionally, where one or more light sources are provided, the CPU can be further programmed to control the light sources. Thus, the system can be dynamically controlled to rotate the chambers in accordance with a pre-determined cycle, and may further control exposure of light to the chambers.

Under certain conditions, while the individual chambers may be used to isolate the growth of a particular species, when a plurality of species are grown within the same body of water certain added benefits can be realized. For example, it may be beneficial to farm a species of shrimp within one or more of the plurality of chambers and a species of oysters within one or more other chambers, such that the oysters may be exposed to the waste of the shrimp for naturally filtering the waste and benefiting the growth of the oysters. In this regard, the growth of multiple species within the aquaculture system can provide synergistic benefits amongst each of the species.

Various organisms to be farmed using the aquaculture system may include: fish, crustaceans, mollusks and aquatic plants. Virtually any aquatic species can be farmed using the aquatic systems and methods described herein.

The chamber generally comprises: a bottom portion extending horizontally to define an area of the chamber, one or more walls extending vertically about a periphery of the bottom portion, and a top portion adapted to extend horizontally to abut the one or more walls at a top end thereof. The top portion may include a lid for opening and closing a volume within the chamber. Thus, the bottom portion, one or more vertical walls, and the top portion generally form a containment chamber for housing one or more species of organisms during a farming cycle.

In certain embodiments, it may be beneficial to provide a balancing weight attached to the bottom portion of the chamber, or otherwise design the chamber to comprise more weight at the bottom portion, such that the chamber remains upright throughout a continuous cycle of the rotating path. In other embodiments, the design of the continuous linkage mechanism is such that added weight at the bottom portion is not necessary.

The chamber may further comprise a plurality of apertures disposed about the surface area thereof. The apertures may be very small on the order of one millimeter (1 mm) in diameter, and upwards of several centimeters or larger, depending on the size of the organisms being grown. For example, certain shrimp may require a relatively smaller aperture size whereas salmon might survive better with a relatively large aperture size. The size of apertures may be consistent or may be randomly disposed about the surface area of each chamber. Thus, those having skill in the art will be required to determine an appropriate chamber having the desired aperture size for growing a specific aquatic organism.

In some embodiments, the chambers may comprise screen mesh material such as a metallic or plastic screen mesh, in any design so long as the overall rigidity of the chamber can be maintained.

The chambers can be manufactured from metal, plastics, or wood; however, it is preferable to use chambers manufactured from light-weight aluminum or composite materials such that the weight of each chamber is minimized for convenient use. It may also be beneficial to use materials that do not rust or degrade in moist or harsh environments.

The aquatic system, having several chambers coupled to a continuous linkage mechanism for rotating the chambers about a cyclical path, is generally placed in a body of water. The body of water can be any naturally occurring body of water including oceans, lakes, rivers, ponds and the like, or any man-made body of water including tanks, raceways, pools, and the like. Because the aquatic system utilizes vertical space, a smaller operational area can be used to produce an equivalent amount of harvested organisms when compared to prior art aquaculture systems. Thus, efficiency is greatly improved with the aquaculture systems and methods described herein.

It should be noted that a plurality of aquaculture systems as described herein can be provided within a shared body of water. In this regard, two or more systems can be adjacently positioned along a raceway or within an ocean or other body of water. Thus, the vertical space utilized by each system within the body of water significantly improves the volume of organisms capable of being harvested within an area or footprint when compared to prior art systems.

The continuous linkage mechanism can be built in accordance with many embodiments. Because it would be impossible to list every variation, two preferred embodiments are hereinafter disclosed. Upon a review of this disclosure, those having skill in the art will be enabled to create a myriad of variations which achieve the goal of translating the plurality of chambers along a cyclical path within a body of water, and such variations may be required depending on the targeted species for growth and the circumstances surrounding a particular application.

### EXAMPLE 1

In a first example, an aquaculture system comprises: a plurality of growing chambers, each of the chambers being coupled to a continuous linkage mechanism. The aquaculture system is deposited into a body of water, such as a tank or other body of water as described above.

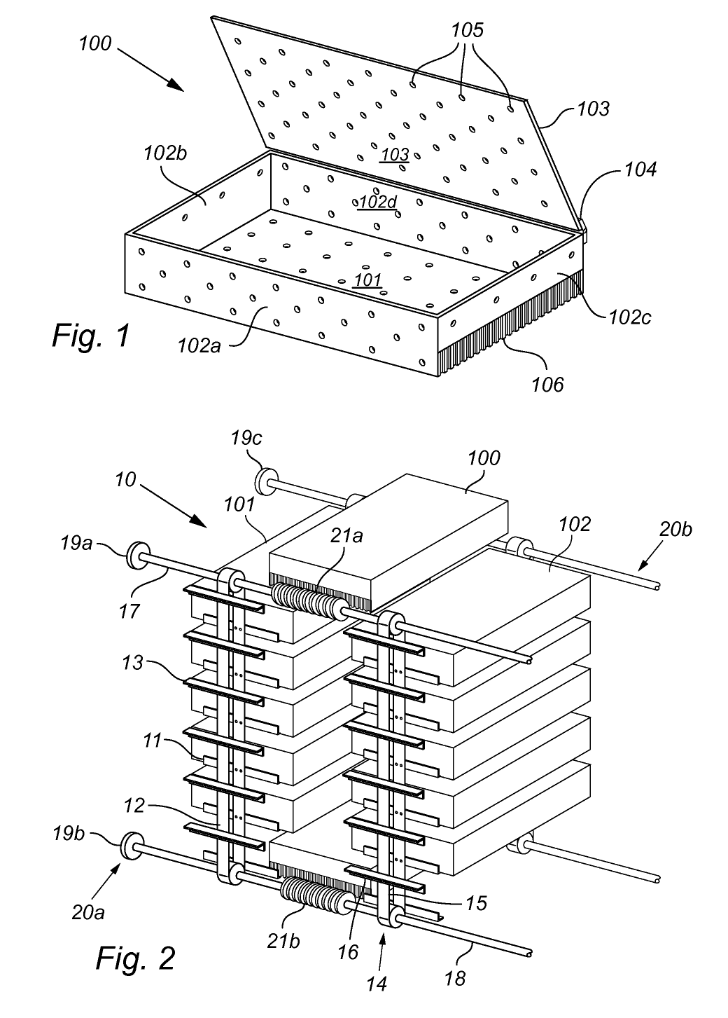

Turning to FIGS. 1-4, a chamber for farming aquatic organisms and an aquatic system in accordance with a first embodiment are each illustrated. In this embodiment, a pair of opposing continuous linkage mechanisms is used to drive cyclical movement of the plurality of chambers about a path within a body of water. Each opposing linkage mechanism comprises a first vertical conveyor adapted to move the chambers upwardly about a first vertical stack, and a second vertical conveyor adapted to move the chambers downwardly about a second vertical stack. Elongated shafts having threaded portions forming a screw-drive are adapted to translate the chambers horizontally between vertical stacks to complete a cyclical path.

FIG. 1 illustrates a containment chamber 100 for containing one or more organisms in accordance with the embodiment of Example 1. The chamber 100 comprises a rectangular box like structure having a bottom portion 101 extending along a horizontal plane to define an area of the chamber, four side walls 102(a-d) extending vertically from a periphery of the bottom portion 101, and a top portion 103 adapted to abut the four walls 102(a-d) at a top end thereof. Here, the entire top portion 103 is coupled to a wall 102d at a hinge 104 disposed at a top end of the wall 102d. A threaded portion 106 extends along opposing external sides 102b; 102c of the chamber for engaging a conjugate portion of a threaded screw-drive disposed about a continuous linkage mechanism (shown in FIG. 2). The entire chamber 100, including the top portion 103, bottom portion 101, and side walls 102(a-d), further comprises a plurality of apertures 105 disposed thereon for promoting fluid communication between the outer environment and an inner volume contained within the chamber. In this regard, vital nutrients and other materials can be passed through the apertures.

The aquatic system, in accordance with the embodiment above, is illustrated in FIG. 2, wherein the system 10 comprises a pair of opposing linkage mechanisms 20a; 20b, respectively. A plurality of chambers 100 are nested within the linkage mechanisms, and adapted to ascend about a first vertical stack of chambers 101, descend about a second vertical stack of chambers 102, and translate laterally therebetween at a top end and a bottom end of the aquaculture system.

A first opposing linkage mechanism 20a comprises a first vertical conveyor 11 having first belt portion 12 and a plurality of first shelves 13 associated therewith, and a second vertical conveyor 14 having a second belt portion 15 and plurality of second shelves 16 associated therewith. The first and second vertical conveyors 11; 14 are rotationally driven by a pair of shafts 17; 18, respectively, including a top elongated shaft 17 and a bottom elongated shaft 18 disposed at respective top and bottom ends. As the shafts rotate, the belt portion of each vertical conveyor is rotated, thus the associated shelves are adapted to move therewith. Each of the shafts is fixed at either end 19a; 19b to a rigid structure or housing. A bearing or similar device can be implemented for reducing friction and improving rotation of the shafts. The second opposing linkage mechanism 20b is substantially similar to the first opposing linkage mechanism. Each of the shafts is configured with a threaded portion 21a; 21b extending along the shaft body and adapted to translate the chambers laterally from the first vertical stack to the second vertical stack. The threaded portions are configured such that the translation between vertical stacks is timed in sync with the ascending and descending movement of the chambers in order to provide a smooth translation about the cyclical path.

In this regard, a first chamber is adapted to ascend upwardly about the first vertical stack while nested between the opposing continuous linkage mechanisms, and subsequently translate horizontally at a top end from the first stack to the second stack before descending downwardly about the second vertical stack, wherein the first chamber is then returned by a horizontal movement from the second stack to the bottom of the first stack along a bottom end of the system. The vertical conveyors cooperatively function to move the chambers vertically in an upward or downward direction about the respective vertical stacks. The rotating shafts with screw-drive elements function to translate the chambers between the vertical stacks.

Thus, the threaded portion of the chamber and the screw-drive portion of the rotating shafts form a joint whereby the chambers are coupled to the continuous linkage mechanism.

The shafts can be driven by any of: a motor, a combination of motors, or any other rotational motion device known in the art.

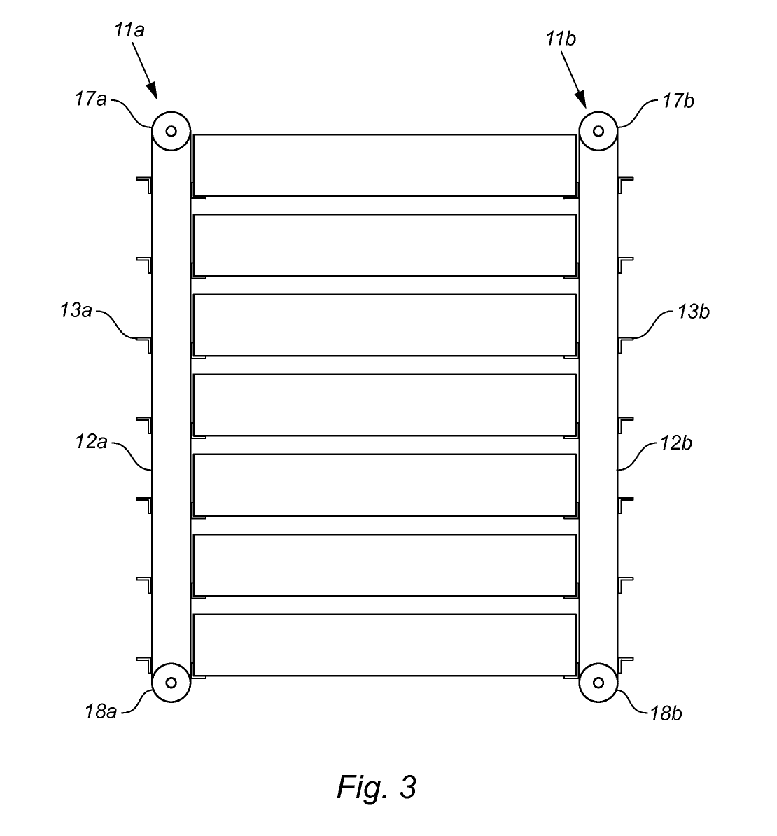

FIG. 3 illustrates a side view of the aquaculture system of FIG. 2. The opposing vertical conveyors 11a; 11b are each shown to include a belt portion 12a; 12b attached to an upper rotating shaft 17a; 17b positioned at a top end and a lower rotating shaft 18a; 18b positioned at a bottom end. Each of the belt portions comprises a plurality of shelves 13a; 13b associated therewith. Each of the shelves is adapted to receive a nested chamber and move the chamber vertically during a system cycle. The belt portions may comprise a cable, chain, rope, or other filament-like structure.

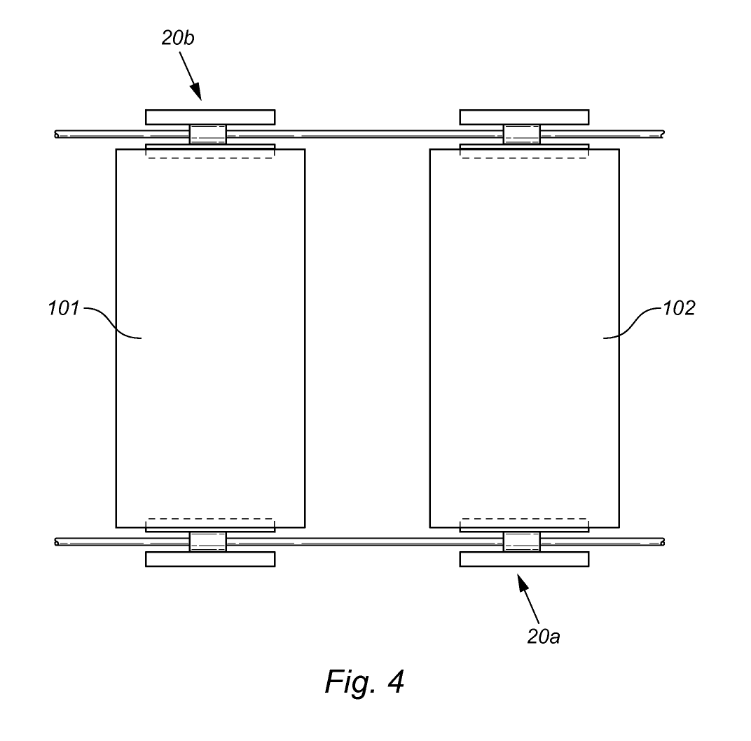

FIG. 4 illustrates a top view of the aquaculture system, wherein two vertical stacks 101; 102 are shown being positioned between opposing continuous linkage mechanisms 20a; 20b, respectively.

### EXAMPLE 2

In a second example, an aquaculture system comprises: a plurality of growing chambers, each of the chambers being coupled to a continuous linkage mechanism. The continuous linkage mechanism comprises at least one loop-drive system, and may comprise two loop-drive systems. In this embodiment, the loop drive system generally comprises a loop of cable, rope, chain, or other filament-like structure. The loop further comprises a plurality of annular nodes positioned along the circumference of the loop, and a plurality of pins, each pin extending through a respective annular node and chamber to form a joint. Thus, each of the plurality of chambers is coupled to the loop by a pin extending through the linkage mechanism and the respective chamber. The loop is driven across a series of pulleys and/or motors for translating the loop along a cyclical path.

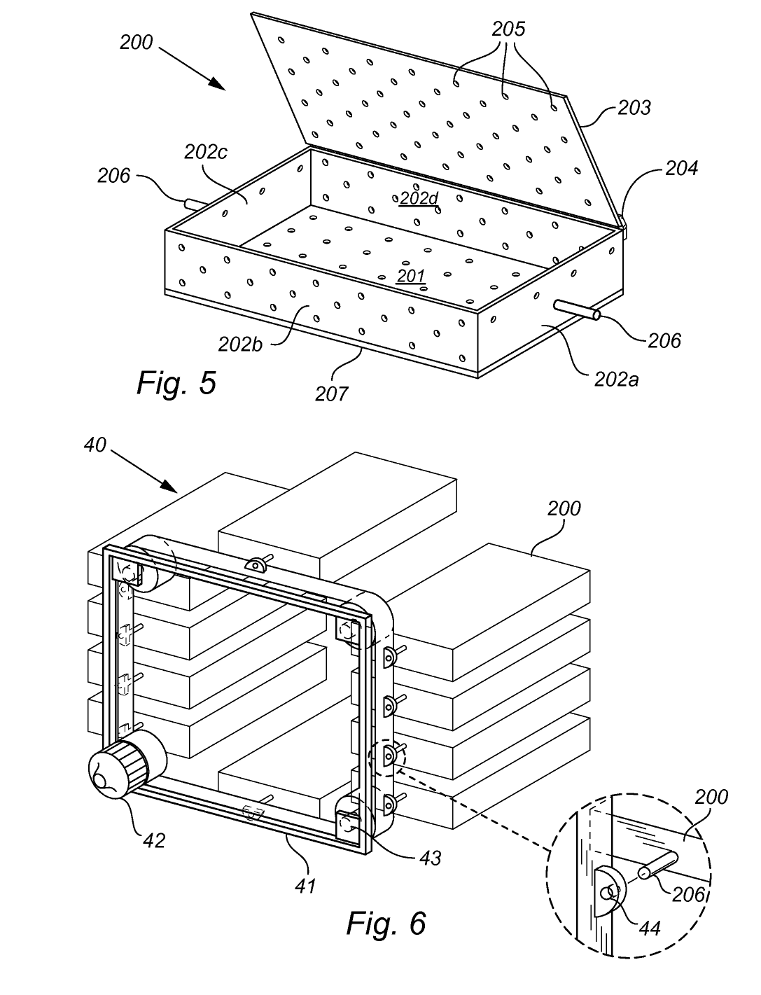

Turning to FIG. 5, a chamber is shown in accordance with the embodiment of Example 2. The chamber 200 comprises a rectangular box like structure having a bottom portion 201 extending along a horizontal plane to define an area of the chamber, four side walls 202(a-d) extending vertically from a periphery of the bottom portion 201, and a top portion 203 adapted to abut the four walls 202(a-d) at a top end thereof. Here, the entire top portion 203 is coupled with a wall 202d at a hinge 204 disposed at a top end of the wall 202d. The entire chamber 200, including the top portion 203, bottom portion 201, and side walls 202(a-d), further comprises a plurality of apertures 205 disposed thereon for promoting fluid communication between the outer environment and an inner volume contained within the chamber. In this regard, vital nutrients and other materials can be passed through the apertures. To adapt the chamber for movement about the cyclical path formed by the continuous linkage mechanism, the chamber comprises a pin 206 disposed at opposing sides of the chamber. The pin can be fixed to the side walls of the chamber, or attached with a bearing or similar device for providing rotational capability. It should be noted that when using a fixed pin, the pin may be attached to the linkage mechanism at a bearing or similar device for providing rotation. Thus, even a fixed-pin chamber is capable of individualized rotation about the linkage mechanism. The chamber can comprise a balancing weight or added weight 207 of the bottom portion for the purpose of maintaining the chamber in an upright position throughout translation about the cyclical path.

FIG. 6 illustrates the aquaculture system 40 in accordance with the embodiment of Example 2. The system comprises a continuous linkage mechanism 41 having a plurality of chambers 200, as illustrated in FIG. 5, being coupled therewith. The continuous linkage mechanism can comprise a loop-drive system. The loop comprises a cable, rope, chain, or other filament-like structure sufficient to hold the weight and torque associated with the system and chambers thereof. The loop is driven by one or more motors 42, and may include up to several pulleys 43. The loop comprises a plurality of annular nodes 44. Each of the nodes is individually adapted to receive a pin 206 extending therethrough for attaching a respective chamber 200. In this regard, the node, chamber, and pin extending therethrough form a joint whereby the chamber is coupled to the continuous linkage mechanism. As the loop-drive system is driven by the motor, each of the coupled chambers also translates about the cyclic path.

In a first variation, a second loop-drive system is disposed on the opposing side of the chambers.

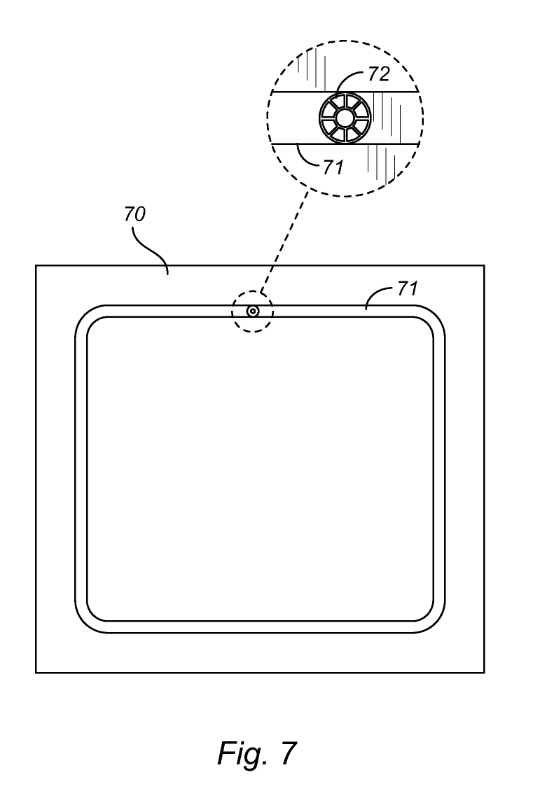

Alternatively, a housing or panel structure 70, as illustrated in FIG. 7, can be etched with a channel 71 such that the pins positioned on the chamber at the side opposite of the loop-drive system may be retained in a fixed track. In this regard, the pins may further comprise a bearing or wheel 72 for moving within the channel of the housing or panel structure.

### OTHER EXAMPLES

Other examples and embodiments will become apparent to those having skill in the art. A chain, cable, rope, or other driving mechanism can be used to move the chambers through each position of the cyclical path.

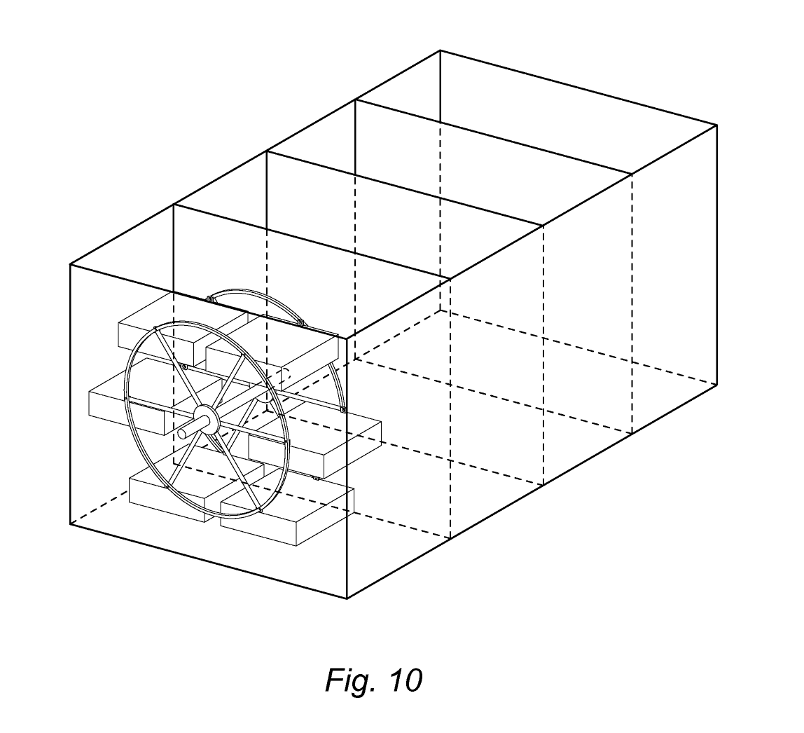

Alternatively, a fixed rigid loop structure 90, or wheel, can be attached to the plurality of chambers 200 and driven by a wheel and motor assembly in a manner similar to an amusement park Ferris wheel as illustrated in FIG. 9. The chambers can be coupled to the rigid loop structure with pins, bearings, or other joints known in the mechanical art.

In order to introduce and harvest organisms within the chamber, each of the chambers may comprise a lid, such as a hinged lid or a sliding lid or other lid.

Moreover, a tank can be provided with multiple wells as illustrated in FIG. 10. Each well can receive one or more aquaculture systems in accordance with the above embodiments.

### METHODS FOR AQUACULTURE FARMING USING THE AQUACULTURE SYSTEMS HEREIN

In another aspect, a method for farming one or more species of aquatic organisms using the aquaculture systems described herein is provided.

In an embodiment, the method comprises:
(i) placing one or more organisms in one or more chambers of a plurality of chambers in accordance with the aquaculture systems described herein; and
(ii) translating the one or more chambers about a cyclical path within a body of water.

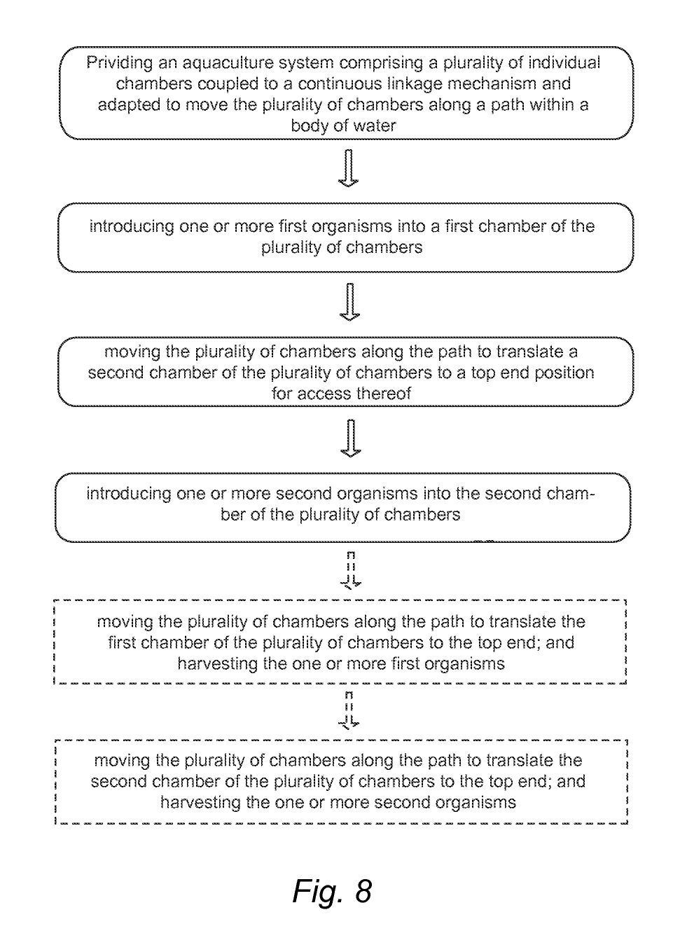

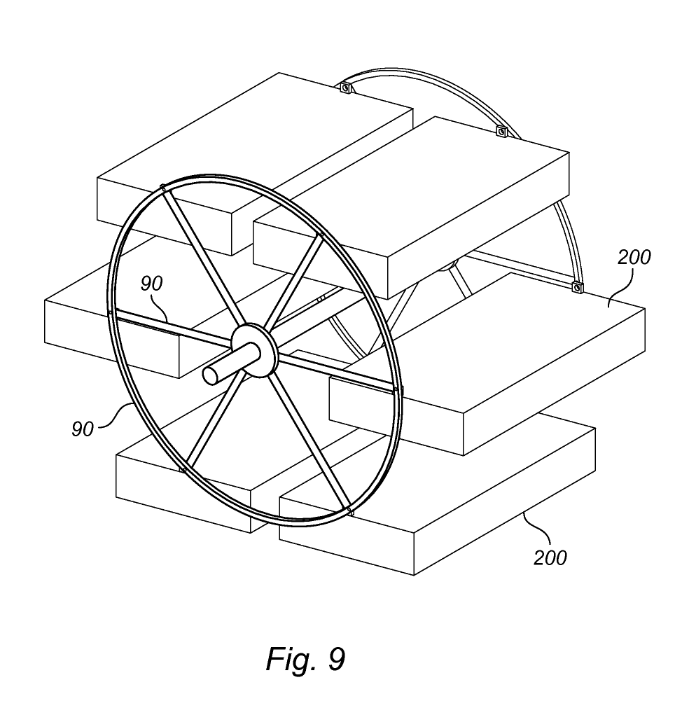

In another embodiment as illustrated in FIG. 8, within an aquaculture system comprising a plurality of individual chambers coupled to a continuous linkage mechanism, wherein the continuous linkage mechanism is adapted to move the plurality of chambers along a path within a body of water, a method for aquaculture farming, comprises:
introducing one or more first organisms into a first chamber of the plurality of chambers;
moving the plurality of chambers along the path to translate a second chamber of the plurality of chambers to a top end position for access thereof; and
introducing one or more second organisms into the second chamber of the plurality of chambers.

The method may further comprise:
moving the plurality of chambers along the path to translate the first chamber of the plurality of chambers to the top end; and
harvesting the one or more first organisms.

Moreover, the method may further comprise:
moving the plurality of chambers along the path to translate the second chamber of the plurality of chambers to the top end; and
harvesting the one or more second organisms.

Within these methods for farming aquaculture, the first and second organisms may be harvested concurrently, or alternatively, the first organisms may be harvested during a first period of time and the second organisms may be harvested during a second period that is subsequent to the first period. In this regard, organisms can be grown within the various chambers in a manner for harvesting at regular intervals or periods as desired or necessary.

Moreover, these methods may be performed using two or more aquaculture systems positioned adjacently within the body of water, simultaneously.

Other methods involving the growth of aquatic organisms within a plurality of chambers and rotating the chambers about a cyclical path within a body of water such that the depth of the body of water is efficiently utilized and the chambers are cycled from a bottom to a top end of the body of water during farming may be contemplated from this disclosure and are therefore deemed to be within the spirit and scope of the invention.

Thus, in certain embodiments, the systems and methods described herein can be adapted to mimic or modify the diurnal cycle for providing a mechanism for enhancing the growth and development of farmed species. This can be accomplished by providing a source of light within a tank or chamber or similar environment and controlling the period of exposure of the light and intervals between light and darkness within the immediate environment of the farmed organisms. Alternatively, the chambers can be configured to cycle such that desirable exposure to light and other nutrients becomes achievable.

In certain embodiments, the systems and methods described herein can be utilized to provide enhanced bio security. For example, by providing the system contained within a body water in an indoor environment, exposure to certain contaminants and or pathogens can be controlled. Additionally, exposure to natural predators is similarly controlled. Moreover, in open bodies of water, by providing chambers which isolate the farmed species, the systems described herein provide added controls against natural predators and other environmental factors.

1. An aquaculture system, comprising:
a continuous linkage mechanism; and
a plurality of chambers,
said plurality of chambers including a first chamber, the first chamber comprising:
a bottom portion extending within a horizontal plane and defining an area of the first chamber,
one or more walls extending vertically about a periphery of the bottom portion, and
a top portion adapted to extend horizontally to abut the one or more walls at a top end thereof, the top portion comprising a lid for opening and closing a volume within the first chamber; and
a second chamber, the second chamber being substantially similar to said first chamber;
each of said plurality of chambers further comprising a joint at a side thereof, the joint being configured to engage the respective chamber and the continuous linkage mechanism, such that each of the chambers of the plurality of chambers is individually coupled to the continuous linkage mechanism;
wherein the continuous linkage mechanism is configured to move with said plurality of chambers along a path within a body of water.

2. The aquaculture system of claim 1, wherein the continuous linkage mechanism is one of:
a chain, rope, or a series of connectors and linkages.

3. The aquaculture system of claim 1, wherein one or more chambers of said plurality of chambers comprise a plurality of apertures disposed about a surface thereof, the apertures being configured to facilitate communication of water therethrough.

4. The aquaculture system of claim 3, wherein the first chamber comprises a plurality of first apertures disposed about a surface thereof, the first apertures having a first size, and wherein the second chamber comprises a plurality of second apertures disposed about a surface thereof, the second apertures having a second size that is larger than the first size of the first apertures.

5. The aquaculture system of claim 1, wherein the top portion is connected to one of the one or more walls at a hinge to form a lid.

6. The aquaculture system of claim 1, wherein the joint comprises a pin extending through the continuous linkage mechanism and the respective chamber.

7. The aquaculture system of claim 1, wherein the joint comprises a pin extending through the continuous linkage mechanism and the respective chamber.

8. The aquaculture system of claim 7, wherein the joint further comprises a bearing disposed between the continuous linkage mechanism and the respective chamber for enhancing rotational engagement between the respective chamber and the continuous linkage mechanism.

9. The aquaculture system of claim 1, wherein said joint comprises a first threaded portion extending along a side of the respective chamber, and a second threaded portion extending along the continuous linkage mechanism, wherein the first and second threaded portions are configured to form a screw-drive for translating the respective chamber about the path.

10. The aquaculture system of claim 9, further comprising a vertical conveyor mechanism, the vertical conveyor mechanism comprising a belt and a plurality of shelves attached to the belt, the belt and shelves being configured to move the chambers vertically along the path.

11. The aquaculture system of claim 1, wherein said body of water is one of: a tank, raceway, or a man-made body of water.

12. The aquaculture system of claim 1, wherein said body of water is a naturally-formed body of water.

13. An aquaculture system, comprising:
a plurality of chambers coupled to a continuous linkage mechanism;
the continuous linkage mechanism being configured to translate each of said chambers about a cyclical path within a body of water, the cyclical path including:
a first position at a top end of the cycle,
a second position at a bottom end of the cycle, and
a plurality of positions therebetween.

14. The aquaculture system of claim 13, the system including:
a first chamber, the first chamber comprising:
a bottom portion extending within a horizontal plane and defining an area of the first chamber,
one or more walls extending vertically about a periphery of the bottom portion, and
a top portion adapted to extend horizontally to abut the one or more walls at a top end thereof, the top portion comprising a lid for opening and closing a volume within the first chamber; and
a second chamber, the second chamber being substantially similar to said first chamber;
each of said plurality of chambers further comprising a joint at a side thereof, the joint being configured to engage the respective chamber and the continuous linkage mechanism, such that each of the chambers of the plurality of chambers is individually coupled to the continuous linkage mechanism;
wherein the continuous linkage mechanism is configured to move with said plurality of chambers along a path within a body of water.

15. In an aquaculture system comprising a plurality of individual chambers coupled to a continuous linkage mechanism and adapted to move the plurality of chambers along a path within a body of water, a method for aquaculture farming, comprising:
introducing one or more first organisms into a first chamber of the plurality of chambers;
moving the plurality of chambers along the path to translate a second chamber of the plurality of chambers to a top end position for access thereof; and
introducing one or more second organisms into the second chamber of the plurality of chambers.

16. The method of claim 15, further comprising:
moving the plurality of chambers along the path to translate the first chamber of the plurality of chambers to the top end; and
harvesting the one or more first organisms.

17. The method of claim 16, further comprising:
moving the plurality of chambers along the path to translate the second chamber of the plurality of chambers to the top end; and
harvesting the one or more second organisms.

18. The method of claim 16, wherein the first and second organisms are harvested concurrently.

19. The method of claim 15, performed at two or more aquaculture systems positioned within the body of water simultaneously.
